(19) United States
(12) Patent Application Publication
(10) Pub. No.: US 2003/0034072 A1
(43) Pub. Date: Feb. 20, 2003

(54) Valve assembly design

(76) Inventors: Quy B. Bui, Bamberg, SC (US); William D. Fralick, Bamberg, SC (US); Robert Patrick, Bamberg, SC (US)

Correspondence Address: Basam E. Nabulsi, CUMMINGS & LOCKWOOD, Four Stamford Plaza, P.O. Box 120, Stamford, CT, 06904-0120, US

(21) Appl. No.: 10/218,550

(22) Filed: Aug. 14, 2002

Related U.S. Application Data
(60) Provisional application No. 60/313,518, filed on Aug. 20, 2001.

(51) Int. Cl. F16K 21/10

(52) U.S. Cl. 137/514

(57) ABSTRACT

Valve assemblies are provided that are adapted and configured to quickly start up and shut off a spray or liquid flow. Exemplary valve assemblies according to the present disclosure effectively minimize and/or prevent dripping from occurring during the start up and shut off of the valve assembly, and/or at times when flow through the valve assembly is suspended. A non-constant clearance between a spring-biased piston and an elongated member is provided, and an elastic member seals therebetween. As the elastic member interacts with the piston in different clearance regions, variable frictional forces are applied to the piston. In further exemplary embodiments, the surface area for force application from the upstream side exceeds the surface area for application of force from the downstream side. The disclosed valve assemblies have a variety of applications, including spray or liquid flow applications that include nozzles and orifices, such as fuel supply applications, agricultural applications and spray drying applications.

### CROSS-REFERENCE TO RELATED APPLICATIONS

The present application claims the benefit of a co-pending provisional patent application entitled “Anti-Drip Check Valve” filed on Aug. 20, 2001, and assigned Serial No. 60/313,518, the entire contents of which are hereby incorporated by reference.

### BACKGROUND OF THE DISCLOSURE

1. Technical Field

The subject disclosure relates to valve assemblies and, more particularly, to valve assemblies that are adapted and configured to quickly start up and shut off a spray or liquid flow. Exemplary valve assemblies according to the present disclosure effectively minimize and/or prevent dripping from occurring during the start up and shut off of the valve assembly, and/or at times when flow through the valve assembly is suspended. The subject valve assemblies have a variety of applications including, but not limited to, spray or liquid flow applications that include nozzles and orifices, such as fuel supply applications, agricultural applications and spray drying applications.

2. Background of Related Art

A liquid spray system generally includes a pump, a pressure regulator or flow regulator, and a spray nozzle or metering orifice. A prior art liquid spray system that includes a check valve and a spray nozzle is disclosed in commonly owned U.S. patent application No. 5,323,807 to Gauld et al, the disclosure of which is herein incorporated by reference to the extent that it is not inconsistent with the present disclosure.

In operation of a typical liquid spray system, the pump generally supplies liquid at an initial pressure to a flow regulator. The flow regulator then meters or controls the flow rate and/or adjusts the fluid pressure to the desired supply pressure for the spray nozzle. The spray nozzle typically converts the metered fluid into a cloud or other distribution of small droplets having a desired droplet size, volume distribution, and flow rate. For certain applications, the spray system also includes a check valve or shutoff valve which provides precision in the starting and stopping of the flow and minimizes dripping that can occur when the flow is suspended and/or initiated. The check/shut-off valve typically functions to suspend fluid flow at a predetermined pressure to prevent undesired spray quality and/or the dripping of excess spray after liquid flow is suspended. The check/shut-off valve is also generally configured to start the spray only at a predetermined pressure to obtain a consistent spray quality.

In prior spraying applications where the spray system does not include a check/shut-off valve, the result has been that at start up, the fluid first drips or dribbles from the nozzle, and then flows in an increasing stream which develops into a spray as full pump pressure develops, i.e., is delivered to the spray nozzle, and only then is the desired spray pattern achieved. At shut down, a similar sequence has occurred, except in reverse order. Thus, when the pump stops, the spray pattern deteriorates into a small fluid stream which issues from the nozzle for a short period and that stream reverts to a dribble as the pressure at the nozzle approaches zero. The presence of such streams or dribbles is, at the very least, wasteful of the fluid intended to be sprayed and often objectionable or even dangerous.

For example, in the operation of oil burners, when fuel enters the combustion chamber in anything other than the desired spray pattern, the fuel is difficult to ignite, incomplete combustion occurs after ignition, undesired combustion products are produced, and fuel is wasted. Another example is in agricultural spraying operations where insecticides, herbicides, disinfectants and other chemicals are used for a variety of purposes. Here, in addition to wastefulness, other potential problems include skin or foliage burns, eye irritation or injury, and dangerous accumulation of chemicals on surfaces.

Efforts have been made to improve the shortcomings encountered in start up and shut down of spray systems through the use of valve assemblies in combination with spray nozzles. In a typical prior check valve, significant pressure drop occurs as the valve opens because applied pressure on the back of the movable valve member partially cancels supply pressure on the front. There are several potential problems caused by the pressure drop across such a typical check valve. It is necessary to increase system pressure to compensate for reduced flow due to the pressure required to hold the valve open. Failure of a typical check valve could result in higher than specified pressure and flow conditions. Removal of a check valve from a system without a system pressure adjustment could also result in higher than specified pressure and flow conditions.

The operating or opening pressure of a typical check valve assembly is usually significantly lower than the nozzle operating pressure in order to minimize pump capacity or pressure requirements. This lower check valve pressure reduces the effectiveness of the valve in controlling complete spray formation at start up and complete flow stoppage at shut down. Thus, for example, it may be necessary to supply 135 psi of pump pressure to hold a check valve open and to maintain 100 psi in the spray nozzle of a domestic oil burner. Thus, the pressure drop is 35 psi. In this instance, the time interval to reach full pressure and full spray is somewhat reduced as compared to a nozzle without a valve and the time that the nozzle produces a drip, drizzle, small stream or undeveloped spray pattern is also reduced to a degree.

Pressure loss through or across a shut-off valve is an important factor in valve design and use. Pressure loss is typically dependent on the design of the valve and the nozzle or orifice opening. The pressure loss results in flow rate loss at the nozzle. The pressure loss can be due to friction, contraction or expansion, and eddies formed as liquid flows through the valve assembly. The pressure loss generally increases with a decrease in the valve opening. For a conventional check valve (see, for example, U.S. Pat. No. 4,172,465), the valve opening is dependent on the differential pressure across the valve gate. An increase in differential pressure leads to a decrease in pressure loss and vice versa. The pressure loss through or across the check valve increases as coupled to small nozzle openings. The reason is that the small nozzle opening causes an increase in pressure in the chamber between the valve and the nozzle exit, and a decrease in differential pressure across the valve gate. In the valve design disclosed in commonly owned U.S. Pat. No. 5,323,807, pressure loss is minimized by a sealed gas chamber on the downstream side of the valve gate.

While prior art check/stop valve and nozzle combinations have achieved some reduction in the time interval required to reach full pressure and full spray, there is still an objectionable time lapse from the beginning of flow to the development of a full spray pattern. In addition, when the pump is turned off, there is a reduced but still meaningful time before flow ceases entirely. Moreover, conventional check/stop valves generally require added pressure above desired opening pressure to obtain the desired flow rate at the nozzle exit.

Thus, there is a need for an improved valve design that effectively minimize and/or prevent dripping from occurring during the start up and shut off of the valve assembly, and/or at times when flow through the valve assembly is suspended. There is also a need for an improved valve design that addresses the foregoing flow issues without imparting an unacceptable pressure drop/loss across the valve assembly.

### SUMMARY OF THE DISCLOSURE

According to exemplary embodiments of the present disclosure, valve assemblies are provided that advantageously permit quick, responsive commencement of fluid flow through the valve assembly, e.g., to a spray nozzle, and quick, responsive discontinuance of fluid flow through the valve assembly. According to preferred embodiments of the present disclosure, the disclosed valve assemblies effectively prevent or substantially reduce the drips/dribbles from a nozzle or orifice when fluid flow is commenced or discontinued. Exemplary valve assemblies according to the present disclosure may be used, for example, as shutoff valves or check valves, and may be utilized in a variety of applications, including fuel supply applications, agricultural applications and spray drying applications.

The disclosed valve assemblies facilitate fluid flow with minimal pressure drop across the valve assembly. Spray system subassemblies incorporating the disclosed valve assemblies are also disclosed, e.g., subassemblies that include a valve assembly according to the present disclosure and a spray nozzle fixedly or detachably secured relative thereto.

In an exemplary embodiment of the present disclosure, a valve assembly is provided that includes a valve housing that defines an axis of flow. The valve housing also includes an inlet port, i.e., orifice(s) or aperture(s) through which fluid enters the valve housing, and an outlet port, i.e., orifice(s) or aperture(s) through which fluid exits the valve housing. A recess or chamber is defined within the valve housing, within which is positioned an elongated member, e.g., a cylindrical guide rod. The elongated member is generally aligned with the flow axis and may be aligned with the inlet port.

According to a disclosed exemplary embodiment, a piston is movably mounted within the recess of the valve housing. The piston may be substantially cylindrical in shape, defining a substantially cylindrical chamber therewithin. The elongated member, e.g., a cylindrical guide rod, may be positioned within the piston's cylindrical chamber, and the piston typically moves or slides relative to the cylindrical guide rod along the flow axis. Movement of the piston relative to the cylindrical guide rod functions to moderate fluid flow through the valve assembly. Thus, for example, in a first position fluid flow through the valve assembly may be prevented, whereas in a second position fluid flow through the valve assembly may be permitted.

In a disclosed exemplary embodiment of the present disclosure, a clearance is defined between the elongated member (e.g., the cylindrical guide rod) and the piston. A sealing element is positioned within the clearance and is in sealing engagement with the elongated member and the piston. In a first preferred embodiment, the sealing element is an annular elastic member that is positioned within a groove formed in the cylindrical guide rod or the piston. According to exemplary embodiments of the present disclosure, the clearance between the elongated member (e.g., the cylindrical guide rod) and the piston is non-constant, i.e., the clearance between the foregoing structures exhibits variability in the region contacted by the elastic sealing element.

According to a preferred valve assembly embodiment of the present disclosure, the sealing element occupies a region of reduced clearance when the piston is positioned a predetermined first distance from the inlet port of the valve housing, i.e., a piston position wherein the inlet port is open to permit fluid flow therethrough. Passage of the elastic sealing element from a region of reduced clearance to a region of increased clearance reduces the frictional forces exerted on the piston by the sealing element and advantageously permits more rapid closure of the inlet port based on movement of the piston relative thereto. Indeed, passage of the sealing element from a region of reduced clearance to a region of increased clearance (based on piston movement) effects a “snap action” on the piston according to preferred embodiments of the disclosed valve assembly.

In a further exemplary embodiment of the present disclosure, a valve assembly is provided that includes a valve housing defining an axis of flow, an inlet port, an outlet port, and a recess therewithin. An elongated member, e.g., a cylindrical guide rod, is aligned with the flow axis and positioned within the recess of the valve housing. The elongated member defines a flange that extends in a plane perpendicular to the flow axis of the valve housing. A piston is movably mounted within the recess of the valve housing. The piston moves, e.g., slides, relative to the elongated member (e.g., the cylindrical guide rod) within the recess.

According to this further exemplary embodiment, the piston defines a sealing face directed toward the inlet port of the valve housing. The sealing face may include an elastic member for sealing against a valve seat defined by the valve housing, or may be structured to a engage an elastic member associated with, e.g., mounted to, the valve seat. In either case, the sealing face of the piston defines a first surface area that is substantially perpendicular to the flow axis through the valve housing. The piston also defines an abutment face located at (or near) an end opposite the sealing face, directed toward the outlet port of the valve housing. The abutment face may be in the form of an annular ring, e.g., when the piston is substantially cylindrical in design.

A spring is positioned between the flange of the elongated member and the abutment face of the piston to bias the sealing face of the piston into a sealing position relative to the inlet port. Thus, the piston is generally spring biased such that the sealing face is biased into engagement with the valve seat of the valve housing to obstruct fluid flow into and through the valve housing. The spring may take a variety of forms and, in a preferred embodiment, is in the form of a compression spring.

According to the disclosed exemplary embodiment, the surface area of the piston's sealing face exceeds the total surface area of the abutment face. In this way, the available area for receiving a force on the upstream side of the piston, i.e., the sealing face, is greater than the available area for receiving a force on the downstream side of the piston, i.e., the abutment face. The disclosed relationship of the foregoing surface areas of the piston advantageously results in a wide opening for fluid flow through the inlet port and a concomitant reduction in pressure loss or pressure drop across the valve housing.

According to the present disclosure, spray system subassemblies are also provided that include a spray nozzle and a valve assembly having advantageous structural and functional attributes as described herein. The spray nozzle and valve assembly are generally detachably joined to each other, e.g., through cooperative threads, a bayonet mount, or the like, although they may be fixedly joined to each other, e.g., through a weld or the like. The disclosed subassemblies effectively prevent or substantially reduce the drips/dribbles from the nozzle when fluid flow is commenced or discontinued and, in preferred embodiments, provide a low pressure drop across the valve assembly.

Additional advantageous structural features and functionalities of the disclosed valve assemblies and spray system subassemblies will be apparent to persons of skill in the art from the detailed description which follows, particularly when taken together with the figures appended hereto.

### BRIEF DESCRIPTION OF THE DRAWINGS

So that those having ordinary skill in the art to which the present disclosure appertains will more readily understand how to make and use the same, reference may be had to the drawings wherein:

FIG. 1 is a cross sectional view of an exemplary valve assembly according to the present disclosure in a closed position;

FIG. 2 is a cross sectional view of the exemplary valve assembly of FIG. 1 in an open position; and

FIG. 3 is a cross sectional view of the exemplary valve assembly of FIGS. 1 and 2 coupled to an exemplary spray nozzle.

### DETAILED DESCRIPTION OF PREFERRED EMBODIMENT(S)

The disclosed valve assemblies advantageously provide functional benefits in a variety of applications, including fuel supply applications, agricultural applications and spray drying applications. Functional benefits that may be realized using the disclosed valve assemblies include: (i) quick, responsive commencement and shut off of a spray or liquid flow at a predetermined pressure, (ii) prevention (or substantial reduction) of drips/dribbles from a nozzle or orifice upon starting and shutting off a spray or liquid flow, and (iii) providing a flow passage with a minimum pressure loss across the valve assembly. Exemplary valve assemblies according to the present disclosure may be used, for example, as shutoff valves or check valves in spray applications and spray system subassemblies.

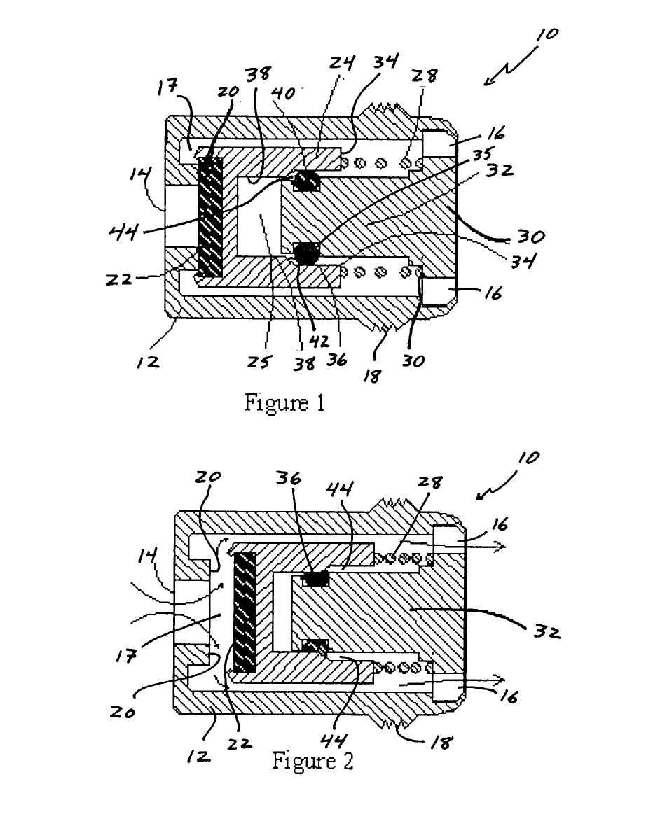

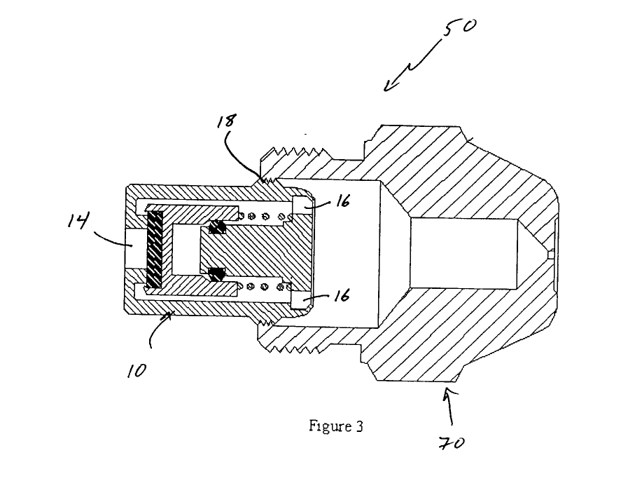

With reference to FIGS. 1 and 2, an exemplary valve assembly 10 is depicted in cross-section in two flow conditions, closed (FIG. 1) and open (FIG. 2). Valve assembly 10 includes a housing 12 that is substantially cylindrical in shape and that defines an inlet port 14, an outlet port 16, and an internal recess 17. Inlet port 14 is substantially circular in shape, whereas outlet port 16 is substantially annular in configuration. Alternative port shapes/designs may be utilized in valve assemblies according to the present disclosure, as will be apparent to persons skilled in the art. Helical threads 18 are formed on the exterior wall of housing 12 to facilitate detachable engagement of valve assembly 10 with ancillary equipment and/or components, e.g., a spray nozzle as shown in FIG. 3. Alternative engagement and/or mounting mechanisms may be utilized according to the present disclosure, e.g., detachable connection such as a bayonet lock, snap lock or the like. It is also contemplated that a nozzle or other ancillary equipment/components may be fixedly attached to valve assembly 10, e.g., through welding or the like.

An annular valve seat 20 is formed adjacent inlet port 14. As shown in FIG. 1, fluid flow through valve assembly 10 is prevented, i.e., valve assembly 10 is shut off, when an elastic member 22 secured to the forward face of movable piston 24 is brought into sealing engagement with valve seat 20. Elastic member 22 is sized and dimensioned to align with and sealingly engage valve seat 20 and, in the exemplary embodiment of FIGS. 1 and 2, is substantially disc-shaped. Elastic member 22 is secured to piston 24 by constriction within an annular extension 26 that extends forwardly relative to piston 24. Alternative systems and mechanisms for securing elastic member 22 to piston 24 may be utilized, as will be apparent to persons skilled in the art, e.g., by gluing, staking or otherwise adhering elastic member 22 thereto.

It is further contemplated that the relative position of elastic member may be reversed, such that an annular elastic member (not pictured) is secured to valve seat 20 and elastic member 22 omitted from piston 24. In this alternative embodiment, the elastic member remains stationary relative to housing 12, whereas piston 24 (without elastic member 22) moves in and out of sealing engagement therewith. In a further alternative embodiment, elastic members may be secured to both valve seat 20 and piston 24, as will be apparent to persons skilled in the art.

Returning to the exemplary embodiment of FIGS. 1 and 2, piston 24 is substantially cylindrical in shape and defines a cylindrical chamber 25 therewithin. A compression spring 28 acts to bias piston 24 toward inlet port 14 and, thereby, depending on the force applied by the fluid on elastic member 22, biases elastic member 22 into sealing engagement with valve seat 20. Compression spring 28 abuts against a flange 30 formed at or near the base of an elongated member 32 (e.g., a cylindrical guide rod) that extends into the recess 17 of valve housing 12. Flange 30 is substantially circular in shape and, in the exemplary embodiment of FIGS. 1 and 2, defines the inner wall of outlet port 16. Compression spring 28 also abuts an annular abutment face 34 defined by piston 24. Compression spring 28 may be secured to flange 30 and/or abutment face 34, e.g., by an adherent or like means, or may be merely captured therebetween. The force exerted by compression spring 28 on abutment face 34 is selected so as to deliver the desired valving functionality to valve assembly 10. More particularly, variation of the strength of compression spring 28 allows a variation in the liquid pressure required to start and/or maintain the flow of fluid/liquid through inlet port 12 of valve assembly 10.

Guide rod 32 extends into chamber 25 defined by piston 24 along the flow axis “F” of valve assembly 10. An annular groove or channel 35 is formed in guide rod 32 which receives an annular elastic member 36. Elastic member 36 is in sealing engagement with guide rod 32 and the inner wall of piston 24, thereby restricting the surface area of piston 24 against which downstream fluid may exert a force that would be contrary to the force exerted on the front face of piston 24 by fluid entering valve assembly 10 through inlet port 14. By restricting the available surface area against which the downstream fluid may act, the pressure drop across valve assembly 10 is advantageously maintained at a minimum.

With further reference to FIGS. 1 and 2, the inner wall of piston 24 includes a first region 38 having a first wall thickness, a second region 40 having a second wall thickness, and a transition region 42 having a variable wall thickness. The wall thickness in first region 38 is greater than the wall thickness in second region 40. Despite the variation in wall thickness over the first, second and transition regions 38, 40, 42, a clearance 44 exists at all points between the inner wall of piston 24 and guide rod 32. A clearance 44 is required to permit piston 24 to move, e.g., slide, relative to housing 12, e.g., in response to the pressure applied by fluid entering through inlet port 14 and/or the closing force applied by compression spring 28. The variable dimension of clearance 44 that is effected in the exemplary embodiment of FIGS. 1 and 2 by the variable wall thickness of piston 24 advantageously provides a “snap action” to the motion of piston 24 as it moves toward inlet port 14, i.e., as flow through valve assembly 10 is discontinued.

More particularly, and with particular reference to FIG. 2, when a sufficient fluid pressure is supplied to inlet port 14, piston 24 is moved to the right against the bias of spring 28, thereby creating a flow opening through inlet port 14. Spring 28 is compressed and the size of chamber 25 is reduced. Moreover, based on the movement of piston 24 relative to guide rod 32, elastic member 36 has moved from second region 40 (wherein a greater clearance exists between piston 24 and guide rod 32), through transition region 42, and into first region 38 (wherein a lesser clearance exists between piston 24 and guide rod 32). Based on the lesser clearance in first region 38, elastic member 36 experiences a greater compression between piston 24 and guide rod 32, and exerts a greater friction force against piston 24.

Thereafter, when fluid pressure/flow to inlet port 14 of valve assembly 10 is reduced, e.g., when an upstream feed pump is turned off or an upstream valve closed, the force exerted on piston 24 by spring 28 will reach a point where it exceeds the force applied by the fluid against elastic member 22 and the frictional force exerted on piston 24 by elastic member 36. At such point, piston 24 will move, e.g., slide, under such spring bias toward inlet port 14. As piston 24 moves to the left in FIGS. 1 and 2, elastic member 36 leaves first region 38 and enter transition region 42 and, due to the reduced compressive force on elastic member 36, a reduced friction force is applied to piston 24. Such reduced friction force results in a greater force differential between the force applied to piston 24 by spring 28 relative to the fluid force applied against elastic member 22, and a resultant acceleration of piston 24 toward inlet port 14. As elastic member 36 exits transition region 42 and enters second region 40, a further reduction in friction forces results, and the movement of piston 24 toward inlet port 14 (all other variables being constant) is further accelerated. Thus, the variable clearance dimensions between piston 24 and guide rod 32 function to accelerate the movement of piston 24 toward inlet port 14, thereby reducing and/or preventing the potential for drips/dribbles when valve assembly 10 goes through a closing action.

Of note, the variable clearance between piston 24 and guide rod 32 may be effectuated in a variety of ways according to the present disclosure. Thus, for example, a transition region 42 may be eliminated from the inner wall of piston 24, i.e., a distinct step from first region 38 to second region 40 may be provided, although such design may prove less desirable if elastic member 36 exhibits a tendency to hang-up on the “step” therebetween. As further examples, the variable clearance may be effectuated without a variation in wall thickness, e.g., by molding or forming a piston of uniform (or substantially uniform) wall thickness that defines different clearance dimensions relative to movable piston 24, and/or by fabricating the inner surface of piston 24 so as to define a frusto-conical configuration. In a further alternative embodiment according to the present disclosure, a groove may be formed in the inner wall of piston 24 (not shown) such that an annular elastic member is positioned therewithin to provide the sealing functions described herein. In such case, the variable dimensional clearance between the piston and elongated member described herein may best be effected through variations in the surface contour of piston 24, e.g., through a variable wall thickness, a frusto-conical design, etc.

With further reference to FIGS. 1 and 2, the pressure drop across valve assembly 10 is maintained at a minimal level based, at least in part, on the relationship between the surface area of the front face of piston 24 (which is defined primarily by the surface area of elastic member 22 in the disclosed exemplary embodiment) relative to the surface area of abutment face 34 thereof, and further based on the sealing of chamber 25 by elastic member 36. The sealing of chamber 25 functions to advantageously reduce the surface(s) available for downstream pressure to be applied in a direction counter to the direction of fluid flow through valve assembly 10.

According to preferred embodiments of the present disclosure, the surface area of the front face of piston 24 generally exceeds the surface area of abutment face 34 by a factor of greater than 1.1:1. As will be apparent to persons skilled in the art, according to exemplary embodiments of the present disclosure, constraints exist with respect to the degree to which the surface area of abutment face 34 may be reduced, e.g., the need to provide a satisfactory surface against which spring 28 may act and/or the minimum wall thickness of piston 24 based on manufacturing and/or functional considerations. Nonetheless, by providing a relative surface area relationship as disclosed herein, the pressure drop across valve assembly 10 may be advantageously maintained at a minimum.

Turning to FIG. 3, an exemplary subassembly 50 is depicted in cross-section, such subassembly including a valve assembly 10 and a spray nozzle 70. Valve assembly 10 corresponds to the valve assembly described herein with reference to FIGS. 1 and 2. Thus, valve assembly 10 includes, inter alia, an inlet port 14, outlet port 16, piston 24, elongated member (guide rod) 32, and spring 28. Moreover, valve assembly 10 includes an elastic member 36 that sealingly engages piston 24 and guide rod 32, and functions within a clearance of variable dimension therebetween.

Exemplary valve assembly 10 also includes outwardly directed helical thread 18 which cooperates with inwardly directed helical thread 72 formed within extension 74 of nozzle 70. As noted previously, alternative means and mechanisms for detachably and/or fixedly connecting valve assembly 10 relative to nozzle 70 may be employed, as will be apparent to persons skilled in the art. Nozzle 70 is of conventional design and includes an orifice 76 through which fluid may be expelled, e.g., as a cloud or other spray pattern. Subassembly 50 may be utilized in a variety of applications including, for example, fuel supply applications, agricultural applications and spray drying applications. Subassembly 50 benefits from the structural and functional benefits of exemplary valve assembly 10, as described herein above, including quick, responsive commencement and shut off of a spray or liquid flow at a predetermined pressure, prevention (or substantial reduction) of drips/dribbles from nozzle 70 upon starting and shutting off a spray or liquid flow, and providing a flow passage with a minimum pressure loss across the valve assembly (and therefore subassembly 50).

Thus, according to exemplary embodiments of the present disclosure, the clearance between a sliding valve gate member (piston) and a carrier of an elastic element (guidance rod) varies as the valve gate member slides along the guidance rod. The clearance advantageously increases and the friction decreases as the valve gate member moves toward the valve seat. The decrease in friction provides quick movement of the valve gate toward the valve seat. In addition, flexible valve members are employed to seal the pressurized liquid line upon and after the valve closes. The valve seat or the valve gate is typically made out of elastic material. The valve seat and valve gate are forced together by a compression spring, and the strength of the spring determines the liquid pressure to start and cut off the downstream liquid flow and the sealing upon and after the shutoff.

A differential force is used according to the present disclosure across the valve gate to widen the opening of the valve gate. The acting area of pressurized liquid onto entrance side of the gate is designed so as to be greater than the backside or downstream side. Thus, the force acting on the larger surface area is greater than the opposing force under the same pressure, and the valve gate is widely opened under the differential force. The wide opening of the valve gate provides a small pressure loss.

Many variations may be incorporated into the disclosed valve assemblies. For example, as noted above, the elastic member between the valve gate member and the guidance rod may be mounted to the guidance rod or a recess formed in the valve gate member. The elastic member may take any shape preferred to achieve the desired frictional characteristics between the sliding valve gate member and the guidance rod, and to completely separate one portion on one side of the valve gate from contacting the pressurized liquid. In addition, the recess formed in the sliding valve gate member may have any shape preferred to achieve the results desired in providing various clearance between the sliding member and the guidance rod. The guidance rod may also have any shape preferred to achieve the results desired in providing various clearance between the sliding member and the guidance rod.

Thus, in fuel burner applications, the advantageous shutoff of the valve assembly according to the present disclosure reduces the amount of dripping of unburned fuel which causes smoke and waste. In chemical applications, such advantageous shutoff reduces the amount of chemical dripping which causes environmental pollution and waste. In spray drying applications, such advantageous shutoff reduces the amount of incompletely dried material produced thereby. In addition, the disclosed shutoff valve positively seals the pressure liquid line as it is closed and, therefore, exemplary embodiments of the disclosed valve assembly may be advantageously utilized as safety valves. The disclosed shutoff valves allow liquid to flow in one direction and positively prevent the opposite flow, thereby providing advantageous functionalities as check valves.

It should be noted that the details disclosed herein are for illustrative purposes only and should not be construed to limit or restrict the scope of the subject disclosure. More specifically, while this disclosure has been described with respect to preferred embodiments, those skilled in the art will readily appreciate that various changes and/or modifications can be made thereto without departing from the spirit or scope of the subject invention.

1. A valve assembly comprising:
(a) a valve housing defining an axis of flow, an inlet port, an outlet port and a recess therewithin;
(b) an elongated member aligned with said flow axis and positioned within said recess of said valve housing;
(c) a piston movably mounted relative to said elongated member within said recess, wherein a clearance is defined between said elongated member and said piston, and wherein movement of said piston moderates flow through said inlet port; and
(d) a sealing element positioned within said clearance and in sealing engagement with said elongated member and said piston;
wherein said clearance is non-constant along said flow axis and wherein said sealing element occupies a region of reduced clearance when said piston is positioned a predetermined distance from said inlet port.

2. A valve assembly according to claim 1, wherein said elongated member is a cylindrical guide rod.

3. A valve assembly according to claim 1, wherein said elongated member includes an annular groove formed therein, and wherein said sealing element is positioned within said groove.

4. A valve assembly according to claim 1, wherein said piston includes a wall having a variable wall thickness and wherein said non-constant clearance is effected by said variable wall thickness of said piston.

5. A valve assembly according to claim 1, wherein at least one of said piston and said elongated member is configured so as to effect said non-constant clearance between said piston and said elongated member.

6. A valve assembly according to claim 5, wherein at least one of said piston and said elongated member defines a frusto-conical configuration.

7. A valve assembly according to claim 1, further comprising an annular valve seat adjacent said inlet port.

8. A valve assembly according to claim 1, further comprising a spring biasing said piston toward said inlet port.

9. A valve assembly according to claim 1, wherein said non-constant clearance includes a first region and a second region, and wherein said first region defines a lesser clearance than said second region.

10. A valve assembly according to claim 9, further comprising a transition region between said first region and said second region.

11. A valve assembly according to claim 1, further comprising a mechanism for joining said valve assembly to a spray nozzle.

12. A valve assembly according to claim 11, wherein said mechanism includes a helical thread.

13. A valve assembly comprising:
(a) a valve housing defining an axis of flow, an inlet port, an outlet port and a recess therewithin;
(b) an elongated member aligned with said flow axis and positioned within said recess of said valve housing, said elongated member defining a flange perpendicular to said flow axis;
(c) a piston movably mounted relative to said elongated member within said recess, said piston defining a sealing face directed toward said inlet port and an abutment face directed toward said outlet port;
(d) a spring positioned between said flange of said elongated member and said abutment face of said piston, said spring biasing said sealing face of said piston into a sealing position relative to said inlet port;
wherein the surface area of said sealing face exceeds the surface area of said abutment face such that the pressure drop across said valve housing is reduced.

14. A valve assembly according to claim 13, wherein said elongated member includes an annular groove formed therein, and further wherein an annular sealing element is positioned within said groove for sealing between said elongated member and said piston.

15. A valve assembly according to claim 13, wherein a non-constant clearance is effected between said elongated member and said piston.

16. A valve assembly according to claim 13, further comprising a mechanism for joining said valve assembly to a spray nozzle.

17. A valve assembly according to claim 16, wherein said mechanism includes a helical thread.

18. A valve assembly according to claim 13, wherein the surface area of said sealing face exceeds the surface area of said abutment face by a factor of at least 1.1:1.

19. A spray system subassembly, comprising:
(a) a spray nozzle defining a fluid inlet and a fluid outlet; and
(b) a valve assembly that includes:
(i) a valve housing defining an axis of flow, an inlet port, an outlet port and a recess therewithin, said valve housing being detachably secured to said spray nozzle with said outlet port of said valve housing in fluid communication with said fluid inlet of said spray nozzle;
(ii) an elongated member aligned with said flow axis and positioned within said recess of said valve housing;
(iii) a piston movably mounted relative to said elongated member within said recess, wherein a clearance is defined between said elongated member and said piston, and wherein movement of said piston moderates flow through said inlet port; and
(iv) a sealing element positioned within said clearance and in sealing engagement with said elongated member and said piston;
wherein said clearance is non-constant along said flow axis and wherein said sealing element occupies a region of reduced clearance when said piston is positioned a predetermined distance from said inlet port.

20. A spray system subassembly according to claim 19, further comprising a spring biasing said piston toward said inlet port.
